(19) United States
(12) Patent Application Publication
(10) Pub. No.: US 2016/0196248 A1
(43) Pub. Date: Jul. 7, 2016

(54) SYSTEM, APPARATUS, METHOD AND COMPUTER PROGRAM PRODUCT TO SET UP A REQUEST FOR, GENERATE, RECEIVE AND SEND OFFICIAL COMMUNICATIONS

(71) Applicant: Musaed Ruzeg N. ALRAHAILI, Sylvania, OH (US)

(72) Inventor: Musaed Ruzeg N. ALRAHAILI, Sylvania, OH (US)

(21) Appl. No.: 14/988,523

(22) Filed: Jan. 5, 2016

(30) Foreign Application Priority Data
Jan. 5, 2015 (SA) 115360181

(51) Int. Cl. G06F 17/24; G06F 17/21

(52) U.S. Cl. CPC G06F 17/24; G06F 17/211

(57) ABSTRACT

A communication system, apparatus, method and computer program product can comprise or operate an input opening or slot to receive an input request, a display, an input device to receive key inputs for the input request, a scanner to generate a soft copy of the input request, a controller to process the input request and provide an output reply, a printer to print a first hard copy of the output reply and a second hard copy of the output reply, an output opening or slot to dispense the first hard copy of the output reply, and a plurality of bins to store the second hard copy of the output reply.

### CROSS-REFERENCE TO RELATED APPLICATIONS

The present application claims the benefit of priority to The Kingdom of Saudi Arabia Patent App. No. 115360181, filed on Jan. 5, 2015, the entire content and disclosure of which is incorporated herein by reference.

### GRANT OF NON-EXCLUSIVE RIGHT

This application was prepared with financial support from the Saudi Arabian Cultural Mission, and in consideration therefore the present inventor has granted The Kingdom of Saudi Arabia a non-exclusive right to practice the present invention.

### SUMMARY

The present disclosure relates generally to communication systems, apparatuses, methods and computer program products (e.g., computer-readable instructions stored on and/or read from a non-transitory computer readable storage medium that, when executed by a computer, a processor or circuitry, cause the same or another computer, processor or circuitry to perform a method, operations or functions based on the instructions). More precisely, embodiments of the disclosed subject matter relate to communication systems, apparatuses, methods and computer program products to generate, receive, and/or send official, authenticated or secure communications.

For example, a communication apparatus or system according to one or more embodiments of the disclosed subject matter can receive a request from a first party and generate a reply from a second party responsive and corresponding to the request in an automatic, secure and efficient way. The first party can be an individual, by way of a terminal, for instance, requesting information and/or documents, e.g., procedures to follow or certificates, and the second party can be an administrator or repository delivering such requested information and/or documentation.

Thus, a controller (or control circuitry) of the communication apparatus or system can be configured to provide an automatic, secure and efficient way to obtain information and/or documentation from the second party by way of a request submitted by the first party directly into the communication apparatus or a corresponding user interface portion of the system. The request from the first party can be treated handled by the controller to automatically perform predetermined tasks, such as identifying the first party and the second party, analyzing the request from the first party, providing information and/or documentation corresponding to the request, demonstrating authenticity of the information and/or documentation, mailing the information and/or documentation (e.g., via traditional courier, via electronic communications, and/or via an unmanned aerial vehicle courier), archiving the information and/or documentation, and/or retrieving the information and/or documentation.

According to one or more embodiments of the disclosed subject matter, a communication system, apparatus, method or computer program product can comprise or operate an input opening or slot to receive an input request, a display, an input device to receive key inputs for the input request, a scanner to generate a soft copy of the input request, a controller to process the input request and provide an output reply, a printer to print a first hard copy of the output reply and a second hard copy of the output reply, an output opening or slot to dispense the first hard copy of the output reply, and a plurality of bins to store the second hard copy of the output reply.

Embodiments of the disclosed subject matter can also comprise an apparatus (or system or method) to generate and output an official communication document comprising: memory; and circuitry configured to receive an input request from a user requesting the official communication document, the input request including data comprised of one or more of a name, a date, an address, a document number, and an electronically readable pattern, transform the input request into a predetermined electronic format, select, responsive to the received input request, a predetermined official communication document template from among a plurality of predetermined official communication document templates stored in the memory, the predetermined official communication document template having a plurality of predefined portions for population with data, set the selected predetermined official communication document template as an intermediate official communication document having the predefined portions for population with data, determine which data of the input request with which to populate the predefined portions of the intermediate official communication document, populate a first portion of the predefined portions of the intermediate official communication document with the determined data of the input request, based on the received input request, receive data from a database, and populate a second portion of the predefined portions of the intermediate official communication document with data received from the database, determine whether the intermediate official communication document is sufficiently populated with the determined data of the input request and the data received from the database, when the intermediate official communication document is not sufficiently populated, output a request to the user to provide additional data to sufficiently populate the predefined portions of the intermediate official communication document, and receive the requested additional data until the predefined portions of the intermediate official communication document are sufficiently populated, when the predefined portions of the intermediate official communication document are sufficiently populated, electronically add a digital signature and document identification data to the intermediate official communication document to create a finalized official communication document, and output the finalized official communication document to the user as the official communication document.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Further, any values or dimensions in the accompanying figures are for illustration purposes only and may or may not represent actual or preferred values or dimensions. Where applicable, some or all select features may not be illustrated to assist in the description of underlying features. In the drawings:

FIG. 1 is a diagrammatic representation of a communication apparatus or system according to one or more embodiments of the disclosed subject matter;

FIG. 2A is a diagrammatic representation of a non-limiting example of an input request from a first party according to one or more embodiments of the disclosed subject matter;

FIG. 2B is a diagrammatic representation of a non-limiting example of an output request from a second party according to one or more embodiments of the disclosed subject matter;

FIG. 3 is a basic flow chart of a communication method or operations according to one or more embodiments of the disclosed subject matter;

FIG. 4 is a basic flow chart of a method or operations to generate an output reply according to one or more embodiments of the disclosed subject matter;

FIG. 5 is a block diagram representation of a portion of a communication apparatus or system according to one or more embodiments of the disclosed subject matter;

FIG. 6 is a functional block diagram of examples of interactions between a communication apparatus, a first party and a second party via a node or virtual private network according to one or more embodiments of the disclosed subject matter;

FIG. 7 is a block diagram representation of a portion of operations implemented according to one or more embodiments of the disclosed subject matter;

FIG. 8 is a basic flow chart of a method or operations according to one or more embodiments of the disclosed subject matter; and

FIG. 9 provides basic information regarding operations performed according to one or more embodiments of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Any reference in the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

As noted above, embodiments of the disclosed subject matter are directed to generating, receiving, and/or sending official, authenticated or secure communications, particularly where a request from a first party can be received, a reply from a second party can be generated responsive and corresponding to the request in an automatic, secure and efficient way.

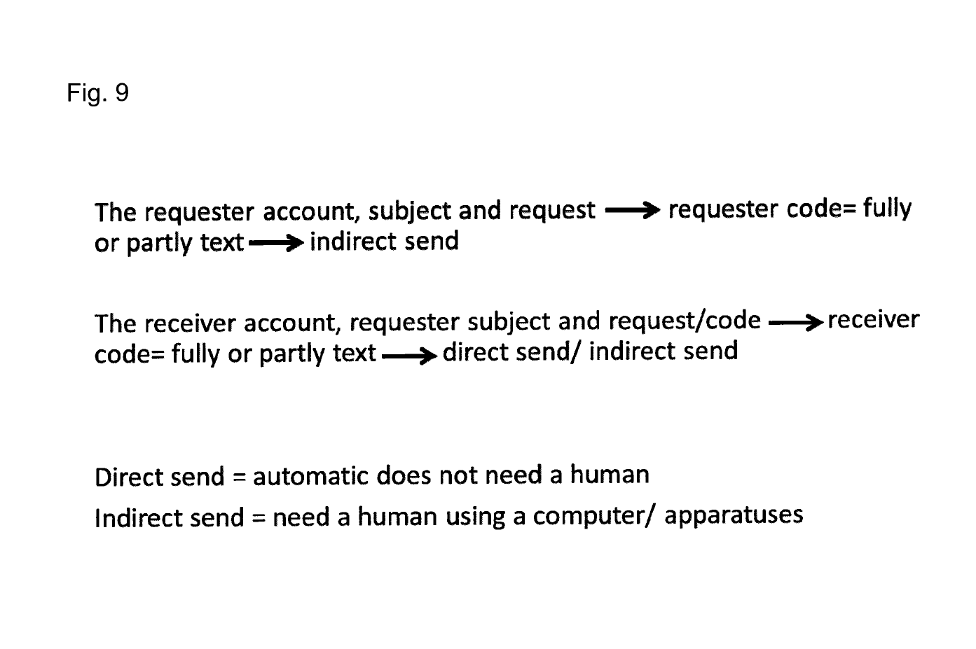

In one or more bodiments of the disclosed subject matter, an input request may be received, where the input request may include a requester code comprised of, for example, a requester account, subject and request, or a receiver code comprised of for example, a receiver account and requester subject and request or code, such as illustrated generally in FIG. 9. The requester code can include full or partial text for an official document from the requester. The receiver code can include full or partial text for the official document. When the requester code is included in the input request, a finalized official document can be indirectly sent to the user by first sending an intermediate official document to a computer or apparatus operated by a human, who is different from the user, to add missing or additional data to the intermediate official document prior to finalizing the official document and sending the finalized official document to the user. When the receiver code is included in the input request, the finalized official document can be directly sent to the user without intervention by the human, so long as the finalized official document includes full or a suitable amount of text for the finalized official document, otherwise, the finalized official document is indirectly sent to the user by first sending the intermediate official document to the computer or apparatus operated by the human to add missing or additional data to the intermediate official document prior to finalizing the official document. Optionally, prior to sending to the user, the finalized official document can be modified to include a digital signature.

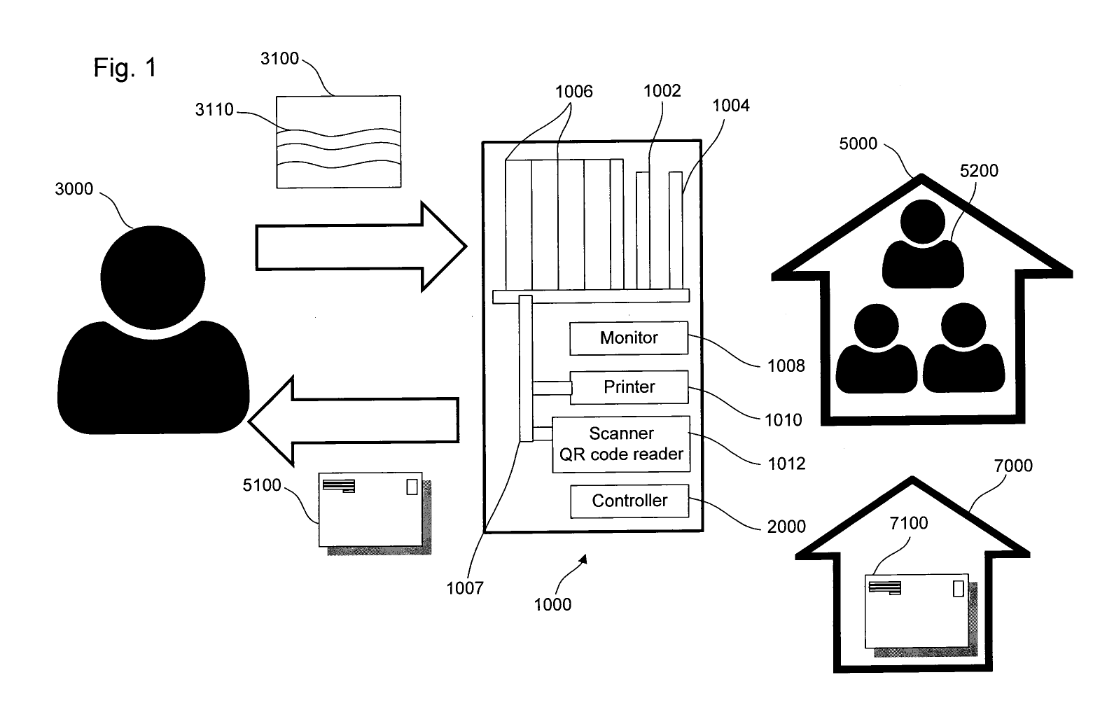

FIG. 1 is a diagrammatic representation of a communication apparatus or system 1000 according to one or more embodiments of the disclosed subject matter.

Apparatus 1000 can communication with and/or be in communication with a first party 3000 and a second party 5000, for instance, simultaneously or non-simultaneously. Optionally, second party 5000 may be considered part of the communication apparatus 1000 at all times or during certain transactions or operations. Alternatively, first party 3000 may be considered part of the communication apparatus 1000 at all times or during certain transactions or operations.

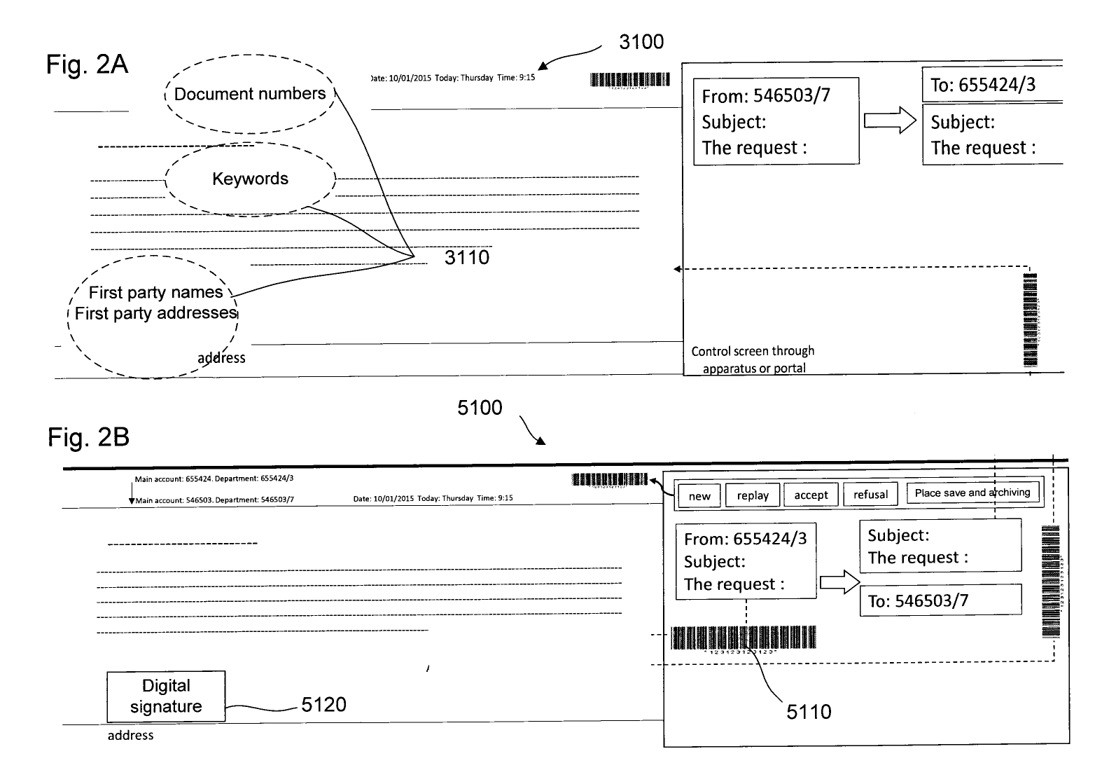

Discussed in more detail below, first party 3000 can provide an input request 3100 to apparatus 1000, such as illustrated in FIG. 2A, and, in response, communication apparatus 1000 can receive from second party 5000 an output reply 5100 or data thereof so communication apparatus 1000 can generate the output reply 5100, such as illustrated in FIG. 2B.

The communication apparatus 1000 can facilitate communications between the first party 3000, e.g., an individual or an individual by way of a portable electronic device (e.g., tablet, smart phone, cell phone, personal digital assistant, laptop computer), and the second party 5000, e.g., server or computer of an agency, a company and/or a system administer. The communication apparatus 1000 can automatically manage and generate official messages, e.g., official letters and/or documents in standardized format and/or with anti-counterfeit measures (e.g., unique bar code, watermark, embedded circuitry), for instance, from the second party 5000 for receipt by the first party 3000 based on request or inputs by the first party 3000 to the communication apparatus 1000.

The communication apparatus 1000 can comprise an input port 1002 (e.g., an opening, slot, etc.), an output port 1004 (e.g., an opening, slot, etc.), a plurality of bins 1006, a user interface 1008 (e.g., a display and keypad, a touch screen, etc.), a printer 1010, a scanner 1012, and a controller 2000, which can control the aforementioned and other components of the communication apparatus 1000. Not expressly illustrated in FIG. 1, the communication apparatus 1000 may also include memory or a memory device to store data, user inputs, data received from first party 3000, and/or data received from second party 5000.

The user interface 1008 can be an electronic device configured to visually display information and receive user input(s). For example, the user interface 1008 may be a display and keypad or keyboard, of the user interface 1008 may be a touchscreen. Optionally, the user interface 1008 may recognize a user's gesture as in input with or without the user touching the display using gesture sensing and recognition circuitry. Optionally or alternatively, the user interface 1008 can receive and/or output audio data or information, such as a voice command.

In one or more embodiments, the first party 3000 can input the input request 3100 to the communication apparatus 1000 via the input port 1002 and the scanner 1012 of the communication apparatus 1000. The first party 3000 can also input the input request 3100 through the user interface 1008 of the communication apparatus 1000. Optionally, input request 3100, or a portion thereof, can be input by the user to the communication apparatus 1000 via a mobile electronic device of the user.

The input request 3100 can be any kind of written message, in paper form and/or electronic form, requesting or petitioning information and/or documentation from the second party 5000, such as case status, procedure to follow, or a particular formalized, verified, secured, and/or authenticated document, for instance, with a user's unique identification.

The first party 3000 can receive an output reply 5100 corresponding to the input request 3100 from the second party 5000 by way of communication apparatus 1000 and/or directly from the second party 5000 or an agent or affiliate of the second party 5000. The output reply 5100 can be received by the first party 3000 via the output port 1004, printed by the printer 1010, for instance, or additionally or alternatively via the user interface 1008, displayed on a display of the user interface and/or sent to a mobile electronic device for output there, for instance, on a display and/or a speaker. The output reply 5100 can be any kind of written message responsive to or answering the input request 3100. In addition, the output reply 5100 can be a letter or message (in paper format and/or electronic format) considered to be an official message containing identification, as well as official documents, such as birth certificates, tax forms, or vehicle title, for instance, in standardized format and/or with anti-counterfeit measures (e.g., unique bar code, watermark, embedded circuitry).

The communication apparatus 1000 can archive the input request 3100 and the output reply 5100 by storing hard copies of the input request 3100 and the output reply 5100 in the plurality of bins 1006. Bins 1006 may be physical bins and/or electronic bins. Thus, the communication apparatus 1000 can store hard copies of official documents prepared by the communication apparatus 1000 and/or can store electronic copies of the official documents in non-transitory computer-readable memory. Optionally, the official documents and/or corresponding data to create or recreate the official documents may be output from the communication apparatus 1000 for storage by the second party 5000, for instance, or a remote server or memory storage device. Optionally, the ability to archive data and documents can be used by the first party 3000 and/or the second party 5000 to retrieve the input request 3100 and the output reply 5100.

Archiving and retrieval of the output reply 5100 and the input request 3100 can be implemented using a conveyer system 1007, for instance. The conveyer system 1007 can transport the hard copies of the input request 3100 and the input request 3100 from the printer 1010 and to each bin of the plurality of bins 1006, and from each bin of the plurality of bins 1006 to the output port 1004. For example, the conveyer system 1007 can rely on belt conveyors, roller conveyors, chutes, pneumatic tube transport systems, a robotic arm, or a combination thereof. Optionally, the conveyor system 1007 may provide the output reply 5100 directly to the output port 1004, without first being provided in one of the bins 1006.

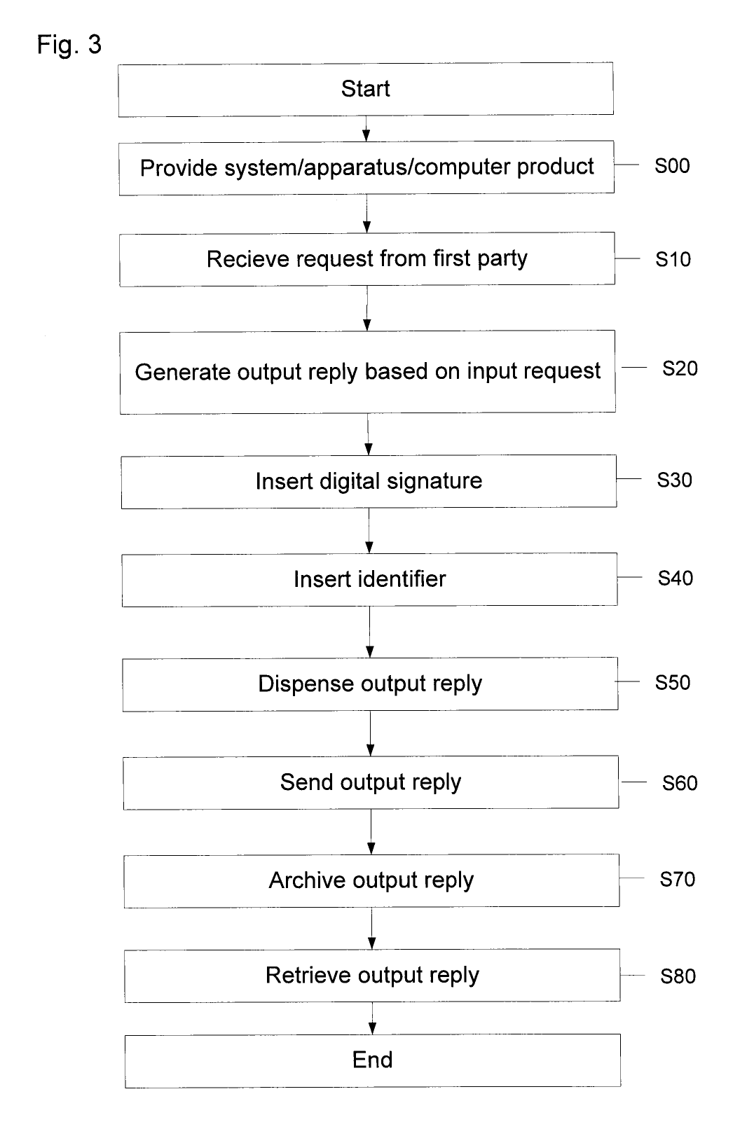

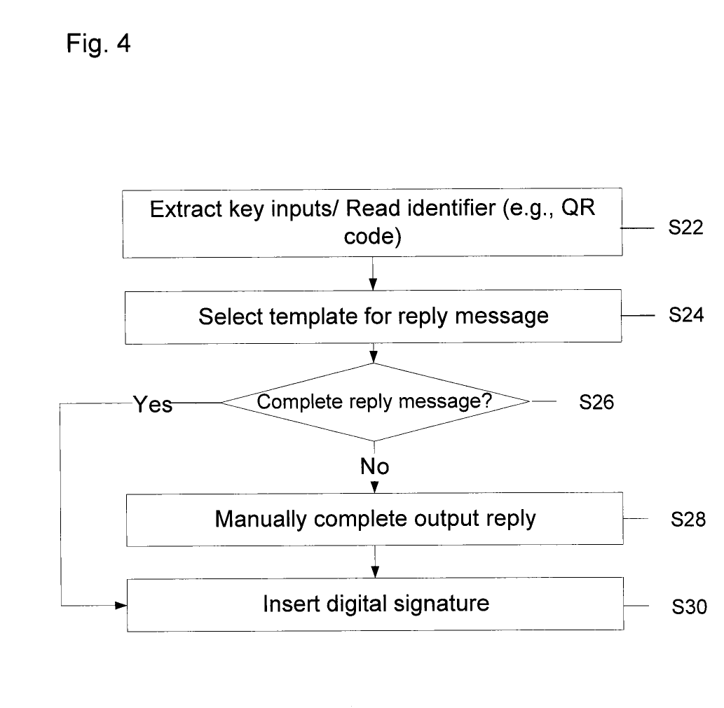

Thus, generally speaking, and as will be described in more detail relative to FIGS. 3 and 4, the communication system 1000 can receive an input request 3100 from the first party 3000. In one embodiment, the input request 3100 can be a paper or plastic (or some other material, such as rubber, cardboard, electronics, metal or combination of materials) document, card, sheet or three-dimensional object, for instance, having data or information already provided thereon or therein provided to input port 1004 of the communication apparatus 1000. Optionally, the data or information may be considered a request for information, data, or documentation. Optionally or alternatively, the input request 3100 can be in electronic format, for instance, received wirelessly by the communication apparatus from a mobile electronic device operated by the first party 3000. In one or more embodiments, the input request 3100 can be a combination of physical and electronic inputs.

The communication apparatus 1000 can process the input request 3100, for instance using controller 2000, or a processor or processing circuitry, and provide feedback to the first party 3000, for instance, requesting additional information (e.g., a further input request, which may be considered part of the initial input request 3100), and/or receiving data or information from the second party 5000 based on the input request 3100 or information or data thereof.

Based on the data or information received from the second party 5000 and optionally the additional information received from the first party 3000, the communication apparatus 1000 can output to the first party 3000 the output reply 5100, which can be in “hard” format (e.g., paper, plastic, etc. or even data or information added externally or internally to the input request 3100 when in physical format). As noted above, the output reply may be output via one of the output port 1004. Optionally or alternatively, the output reply 5100 can be in electronic format, for instance, output (e.g., visual and/or audio) on the user interface 1008 of the communication apparatus 1000 and/or transmitted electronically to a mobile electronic device of the first party 3000. As noted above, the output reply 5100 can be a letter or message considered to be an official message containing identification of the first party 3000 and/or the second party 5000, as well as official documents, such as birth certificates, tax forms, or vehicle title, for instance, in standardized format and/or with anti-counterfeit measures (e.g., unique bar code, watermark, embedded circuitry).

Turning now to FIG. 3, this figure is a flow chart of a method of communicating data or information to a first party according to one or more embodiments of the disclosed subject matter, implemented, for instance, using the communication apparatus 1000 of FIG. 1.

Optionally, in a step S00, a communication apparatus, such as communication apparatus 1000, can be provided.

In a step S10, an input request 3100 can be received at a communication apparatus, for instance, from a first party. As noted above, the input request 3100 can be provided directly by entering the input request 3100 on the user interface 1008 of the communication apparatus 1000. For example, a graphical user interface can be displayed on the user interface 1008 via software instructions performed by the controller 2000. This graphical user interface can have key inputs 3110 to be filled in by the first party 3000. Examples of data for the key inputs 3110 include name(s), address(es), date(s), document name(s), document number(s), identification number(s) (e.g., bank accounts, social security numbers), key word(s), and/or key sentence(s).

Alternatively, the input of the input request 3100 can be performed by inserting a physical medium containing data or a message, such as a piece of paper with a written text, into the input port 1002. The physical message can be converted into electronic format, for instance, using the scanner 1012 and processing circuitry, for instance, controller 2000. For example, the software instructions can rely on optical character recognition tools to convert an image of the input request 3100 provided by the scanner 1012 into machine-encoded text.

As yet another option or alternative, the input request 3100 can be received wirelessly by the communication apparatus 1000, using wireless interface circuitry, from a mobile electronic device of the first party.

In a step S20, an output reply 5100 can be generated based on the input request 3100. Step S20 is further described below relative to FIG. 4.

In a step S30, anti-counterfeit operations can be performed to the output reply 5100 prior to being output. For example, a unique bar code, watermark, embedded circuitry, and/or a digital signature can be added to the output reply 5100, depending upon the physical or electronic format of the output reply 5100, for instance, to show that authentication and integrity of the reply message, e.g., the output reply 5100 was not altered or modified.

For example, insertion of the digital signature 5120 can be performed relying key generation instructions, signing instructions, and signature verifying instructions. The key generation instructions can randomly provide a private key and a corresponding public key, the signing instructions can produce a signature from the private key an a message, and the signature verifying instructions can from the public key and the signature either accept or reject the message.

In a step S40, an identifier 5110 containing key information can be inserted to the output reply 5100, for instance, under the form of an optical machine-readable representation of data, such as a one-dimensional barcode or a two-dimensional barcode such as a QR code. The key information may include keywords, reference numbers, document names, dates, names and addresses of the first party 3000 and/or second party 5000 describing both the content of the input request 3100 and the output reply 5100.

In a step S50, a hard copy of the output reply 5100 can be generated via the printer 1010, and can be dispensed to the first party 3000 via the output port 1004.

Alternatively, an initial soft copy of the output reply 5100, for instance, with the identifier 5110, can be displayed to the first party 3000 on the user interface 1008 of the communication apparatus 1000 and/or can be sent by electronic telecommunication, e.g., text, email, etc., to the first party 3000 and/or the second party 5000 through a network interface 2026 of the controller 2000.

In S60, land mail 7100 containing a second hard copy of the output reply 5100 can be generated by the communication apparatus 1000, for instance, using controller 2000, and sent by sending a mailing request to a mail courier service 7000, or be accessible to the first party 3000 through a node or virtual private network (VPN) 6000 connected to the controller 2000.

In a step S70, the output reply 5100 can be archived by the communication apparatus 1000. A first soft copy of the output reply 5100 can be stored in a memory 2004 of the controller 2000 (or processor or processing circuitry). In addition, a third hard copy of the output reply 5100 can be generated via the printer 1010 and placed into one bin of the plurality of bins 1006 of the communication apparatus 1000.

In a step S80, the first party 3000 and/or the second party 5000 can retrieve a supplementary copy of the output reply 3100, wherein the supplementary copy of the output reply 3100 may be the hard copy archived in S60. The third hard copy may be retrieved only by the first party 3000, only by the second party 5000, and/or only by a third party (e.g., a trusted courier), for instance, using a unique physical or electronic key to open the bin 1006.

The first party 3000 and/or the second party 5000 can provide the identifier 5110 of the output reply 5100 to the communication apparatus 1000. For example, the first party 3000 and/or the second party 5000 can provide a reading of the identifier 5110, e.g., barcode, printed on a piece of paper or any other display support via the scanner 1012 of the communication apparatus 1000. For example, the barcode can be printed from an electronic message according to step S40.

In addition, the controller 2000 can verify the identities of the first party 3000 and/or the second party 5000 to ensure that the first party 3000 and/or the second party 5000 are authorized to retrieve a supplementary copy of the output reply 3100. The identity verification may be performed via physical identification documents such as a driver's license, passport, or credit card that may be electronically uploaded to the memory 2004 of the controller 2000 via the scanner 1012 of the communication apparatus 1000. For example, the controller 2000 via software instructions relying on character recognition tools can recognize key identification elements such as names, physical and/or electronic addresses, date of birth and/or identification numbers and compare them to the some of the key information contained the message identifier 5110.

Once the identifier 5110 and identities have been verified, the printer 1010 of the communication apparatus 1000 can print a supplementary hard copy of the input request 3100 and/or the output reply 5100.

FIG. 4 is a basic flow chart of a method to generate the output reply 5100 of the second party 5000 based on the input request 3100 of the first party 3000 according to one or more embodiments of the disclosed subject matter.

In a step S22, the controller 2000 via software instructions can extract the key inputs 3110 from the input request 3100. The key inputs 3110 can be any kind of semantic information for assessing the request from the first party 3000. For example, the key inputs 3110 can be names, physical and/or electronic addresses, dates, document names, document numbers, identification number (e.g., bank accounts, social security numbers), key words, and/or key sentences.

When a graphical user interface is used by the first party 3000 to enter the input request 3100, the key inputs 3110 can be directly extracted from the step S10.

When the input request 3100 is entered by providing a physical object to the input port 1002, the extraction of the key inputs 3110 can be performed by scanning, optical recognition, text mining, etc. Text mining can include text categorization, text clustering, concept/entity and fact extraction, and production of granular taxonomies, sentiment analysis, document summarization, and entity relation modeling. For example, the key inputs 3110 can be identified by text pattern matching and by searching specific strings of characters that can be stored in the memory 2004 of the controller 2000.

In a step S24, based on the key inputs 3110, a template for the output reply 5100 can be selected by the controller 2000 from a reply database containing a plurality of templates. The reply database can be stored in the memory 2004 of the controller 2000.

The selection by the controller 2000 can be performed by a matching parameter P assigned to each template of the plurality of templates and choosing the template with the highest matching parameter P. Depending on the key inputs 3110, the matching parameter P may take value between 0 and 1, where 1 can indicate a perfect match and 0 can indicate a complete mismatch.

For example, each template can contain fields to be filled with the key inputs 3110 previously extracted in the step S22. Then, the matching parameter P can be computed for each template by measuring how many fields can be filled from the key inputs 3110. Accordingly, a matching parameter P equal to 1 can indicate that all the fields of the template can be filled with the key inputs 3110 extracted in the step S22, while a matching parameter P equal to 0 can indicate that none of the fields of the template can be filled with the key inputs 3110.

In a step S26, the controller 2000 can verify that the output reply 5100 is considered as completed. For example, the completeness verification can be performed by comparing the matching parameter P with a predetermined completeness threshold. If the value of the matching parameter P of selected template used to generate the output reply 5100 is less than or equal to the completeness threshold, the output reply 5100 may be considered as uncompleted, and the process goes to a step S28. If the value of the matching parameter P for the selected template is greater than the completeness threshold the reply message can be considered as completed, and the process goes to the step S30 of the method illustrated in FIG. 3.

In a step S28, the uncompleted reply message can be sent to a person in charge 5200 of the second party 5000 to be manually completed via electronic communication, e.g., instant message system. For example, the person in charge 5200 can be an employee of the third party specially assigned to this task. Once the step S28 has been executed the process goes to the step S30 of the method illustrated in FIG. 3.

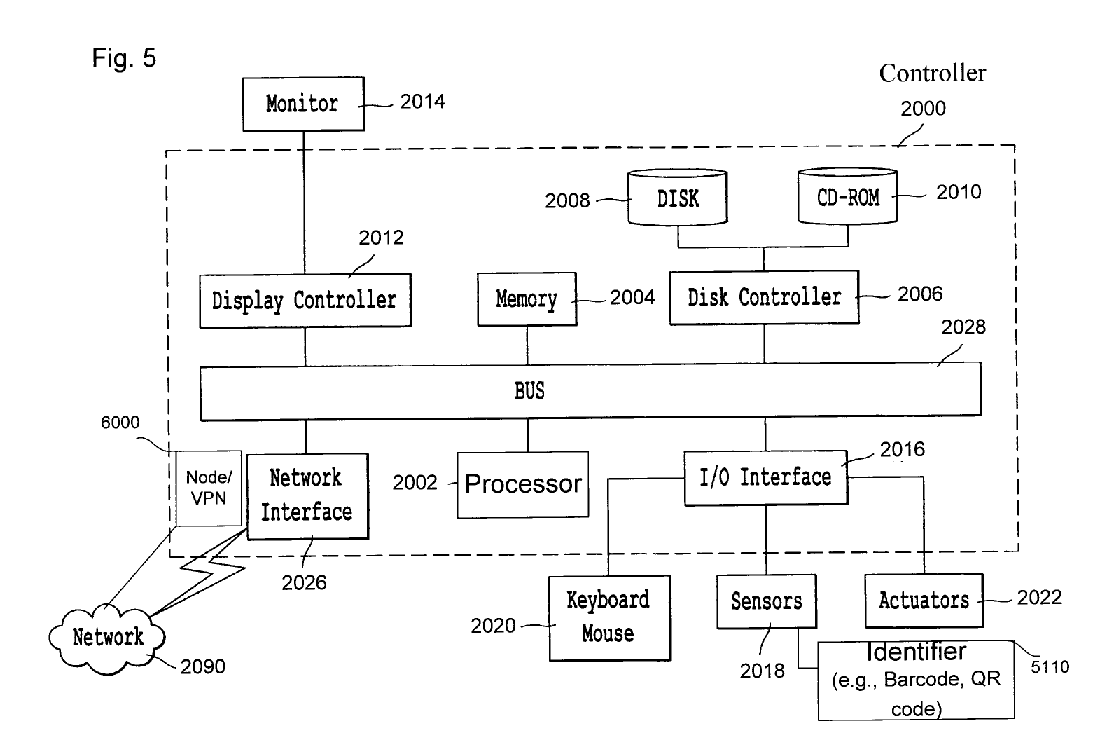

FIG. 5 depicts a controller 2000 (or processor or processing circuitry) that may control the communication apparatus 1000 according to one or more embodiments of the disclosed subject matter.

As shown in FIG. 5, systems, operations, and processes in accordance with this disclosure may be implemented using a processor 2002 or at least one application specific processor (ASP). The processor 2002 may utilize a computer readable storage medium, such as the memory 2004 (e.g., ROM, EPROM, EEPROM, flash memory, static memory, DRAM, SDRAM, and their equivalents), configured to control the processor 2002 to perform and/or control the systems, operations, and processes of this disclosure. Other storage mediums may be controlled via a disk circuitry 2006, which may control a hard disk drive 2008 or optical disk drive 2010.

The processor 2002 or aspects thereof, in an alternate embodiment, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The processor 2002 may be a separate device or a single processing mechanism. Further, this disclosure may benefit form parallel processing capabilities of a multi-cored processor.

In another aspect, results of processing in accordance with this disclosure may be displayed via a display controller 2012 to the display and input device 1008 that may be peripheral to or part of the circuitry 2000. Moreover, the display and input device may be provided with a touch-sensitive interface to a command/instruction interface. The display controller 2012 may also include at least one graphic processing unit for improved computational efficiency. Additionally, the circuitry 2000 may include an I/O (input/output) interface 2016, provided for inputting sensor data from sensors 2018, such as the camera 2001, and for outputting orders to actuators 2022. The sensors 2018 and actuators 2022 are illustrative of any of the sensors and actuators described in this disclosure.

Further, other input devices may be connected to an I/O interface 2016 as peripherals or as part of the controller 2000. For example, the keyboard 2020 may control parameters of the various processes and algorithms of this disclosure, and may be connected to the I/O interface 2016 to provide additional functionality and configuration options, or to control display characteristics. Actuators 2022 which may be embodied in any of the elements of the apparatuses described in this disclosure may also be connected to the I/O interface 2016.

The above-noted hardware components may be coupled to the network 2024, such as the Internet or a local intranet, via the network interface 2026 for the transmission or reception of data, including controllable parameters to a mobile device. A central BUS 2028 may be provided to connect the above-noted hardware components together, and to provide at least one path for digital communication there between.

The network 2090 can be linked to the node or VPN 6000 to directly connect the communication apparatus 1000, the first party 3000 and/or the second party 5000. The node or VPN 6000 can be used to directly send and receive the input request 3100 and the output reply 5100.

In some example embodiments, the communication apparatus, system, or portions thereof may be embodied as, or included as, a component of a communications device with wired or wireless communications capabilities. In this regard, the apparatus, system, or portion thereof may be configured to operate in accordance with the functionality of one or more network elements. As noted above, a processor or processing circuitry implemented in embodiments of the disclosed subject matter may be embodied as various means for implementing the various functionalities of example embodiments of the present invention including, for example, a microprocessor, a coprocessor, a controller, a special-purpose integrated circuit such as, for example, an application specific integrated circuit (ASIC), a field programmable gate array (FPGA), a hardware accelerator, processing circuitry and/or the like. According to an example embodiment, the processor or processing circuitry may be representative of a plurality of processors, or one or more multiple core processors, operating in concert. Further, the processor or processing circuitry may be comprised of a plurality of transistors, logic gates, a clock, e.g., oscillator, other circuitry, and/or the like to facilitate performance of the functionality described herein. The processor or processing circuitry may, but need not, include one or more accompanying digital signal processors. In some example embodiments, the processor or processing circuitry is configured (or configurable) to execute instructions stored in a memory device or instructions otherwise accessible to the processor or processing circuitry. The processor or processing circuitry may be configured to operate such that the processor causes an apparatus, a system, or portion(s) thereof to perform various functionalities, operations, or steps as described herein, such as with respect to FIGS. 3 and 4.

Whether configured as hardware or via instructions stored on a computer-readable storage medium (e.g., a non-transitory computer-readable storage medium), or by a combination thereof, the processor or processing circuitry may be an entity configured to perform, and/or cause the apparatus, system or portion(s) thereof to perform operations according to embodiments of the disclosed subject matter while configured accordingly. Thus, in example embodiments where the processor or processing circuitry is embodied as, or is part of, an ASIC, FPGA, or the like, the processor or processing circuitry can be specifically configured hardware for conducting, or causing the performance of, the operations, functionalities or steps described herein, such as with respect to FIGS. 3 and 4.

Alternatively, in example embodiments where the processor or processing circuitry is embodied as an executor of instructions stored on a computer-readable storage medium (e.g., a non-transitory computer-readable storage medium), the instructions can specifically configure the processor or processing circuitry to perform, and/or cause the performance of, the algorithms and operations described herein. In some example embodiments, the processor or processing circuitry is a processor/processing circuitry of a specific device configured for employing example embodiments of the disclosed subject matter by further configuration of the processor or processing circuitry via executed instructions for performing, and/or causing the performance of, the algorithms, methods, and operations described herein, such as with respect to FIGS. 3 and 4.

Memory or memory devices implemented as part of the communication apparatus or system according to embodiments of the disclosed subject matter may be one or more computer-readable storage media (e.g., a non-transitory computer-readable storage media) that may include volatile and/or non-volatile memory. In some example embodiments, the memory can include Random Access Memory (RAM) including dynamic and/or static RAM, on-chip or off-chip cache memory, and/or the like. Further, the memory may include non-volatile memory, which may be embedded and/or removable, and may include, for example, read-only memory, flash memory, magnetic storage devices, e.g., hard disks, floppy disk drives, magnetic tape, etc., optical disc drives and/or media, non-volatile random access memory (NVRAM), and/or the like. Further, the memory may include a cache area for temporary storage of data. In this regard, at least a portion or the entire memory may be included within the processor or processing circuitry as described herein or equivalents thereof.

Further, the memory may be configured to store information, data, applications, computer-readable program code instructions, and/or the like for enabling the processor or processing circuitry and the example apparatus or system to carry out various functions in accordance with example embodiments of the described subject matter. For example, the memory may be configured to buffer input data for processing by the processor or processing circuitry. Additionally, or alternatively, the memory may be configured to store instructions for execution by the processor or processing circuitry.

I/O interface(s) according to one or more embodiments of the disclosed subject matter may be any device or circuit embodied in hardware, software or a combination of hardware and software configured to interface the processor or processing circuitry with other circuitry, devices, user(s), or systems, such as a communications interface and/or a user interface. In some example embodiments, the processor or processing circuitry may interface with the memory via one or more I/O interfaces. The I/O interface(s) may be configured to convert signals and data into a form that may be interpreted by the processor or processing circuitry. The I/O interface(s) may also perform buffering of inputs and outputs to support the operation of the processor or processing circuitry. According to some example embodiments, the processor or processing circuitry and the I/O interface(s) may be combined onto a single chip or integrated circuit configured to perform, or cause the communication apparatus to perform, various functionalities, operations or steps, such as those described relative to FIGS. 3 and 4.

One or more communication interfaces may be implemented as part of communications apparatuses or systems according to embodiments of the disclosed subject matter may be a device component embodied in hardware, software or a combination of hardware and software configured to receive and/or transmit data from/to one or more networks (e.g., radio access networks, local networks, the Internet, an analog network, etc.), a user or users, and/or any other device or module in communication with the communication apparatus or system according to embodiments of the disclosed subject matter. The processor or processing circuitry may also be configured to facilitate communications via the communications interface(s) by, for example, controlling hardware included within the communications interface(s). In this regard, the communication interface(s) may include, for example, one or more antennas, a transmitter, a modem, a receiver, a transceiver and/or supporting hardware, including, for example, a processor or processing circuitry to enable communications via the communication interface(s). Optionally, communication apparatuses or systems according to embodiments of the disclosed subject matter may communicate with various other network elements in a device-to-device fashion and/or via indirect communications.

Communications interface(s) according to embodiments of the disclosed subject matter may be configured to provide for communications in accordance with any of a number of wired or wireless communication standards.

At least one communication interface according to embodiments of the disclosed subject matter may be a user interface, which may be in communication with the processor or processing circuitry to receive user input and/or to present output to a user as, for example, audible, visual, mechanical or other output indications. The user interface may include, for example, a keyboard, a mouse, a joystick, a display, e.g., a touch screen display, a microphone, a speaker, or other input/output mechanisms. Further, the processor or processing circuitry may comprise, or be in communication with, user interface circuitry configured to control at least some functions of one or more elements of the user interface.

The processor/processing circuitry and/or user interface circuitry may be configured to control one or more functions of one or more elements of the user interface through computer program instructions (e.g., software and/or firmware) stored on a memory accessible to the processor or processing circuitry (e.g., memory device). In some example embodiments, the user interface circuitry is configured to facilitate user control of at least some functions of the communications apparatus or system through the use of a display and configured to respond to user inputs. The processor or processing circuitry may also comprise, or be in communication with, display circuitry configured to display at least a portion of a user interface, where the display and the display circuitry can be configured to facilitate user control of at least some functions of apparatus.

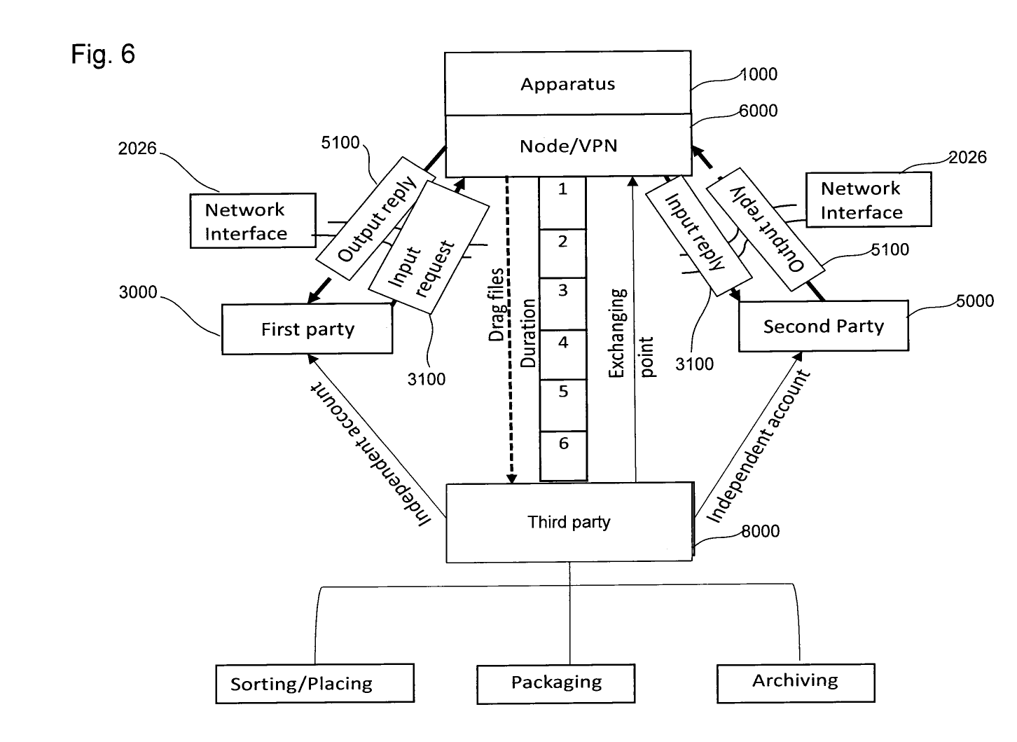

FIG. 6 is a functional block diagram of examples of interactions between the communication apparatus 1000, the first party 3000 and the second party 5000 through the node or VPN 6000 according to one or more embodiments of the disclosed subject matter.

The node or VPN 6000 can be configured to establish a virtual point-to-point connection or access between the communication apparatus 1000, the first party 3000, and the second party 5000. The node or VPN 6000 can be used by the first party 3000 to submit the input request 3100 to the second party 5000 via the apparatus 1000 and receive the output reply 5100 from the second party 5000 via the apparatus 1000. Similarly, the node or VPN 6000 can be used by the second party 5000 to send the output reply 5100 to the first party 3000 via the apparatus 1000 and receive the input request 3100 from the first party 3000 via the apparatus 1000.

Optionally, the node or VPN 6000 can be used by a third party 8000 to supervise, authorize, certify and/or confirm the communications between the first party 3000 and the second party 5000. The third party 8000 can be an independent party having no interest with the first party 3000 and the second party 5000, such as a certification company or organization. The third party 8000 can supervise, authorize, certify and/or confirm the communications between the first party 3000 and the second party 5000 by accessing and controlling the content of the input request 3100 and the output reply 5100.

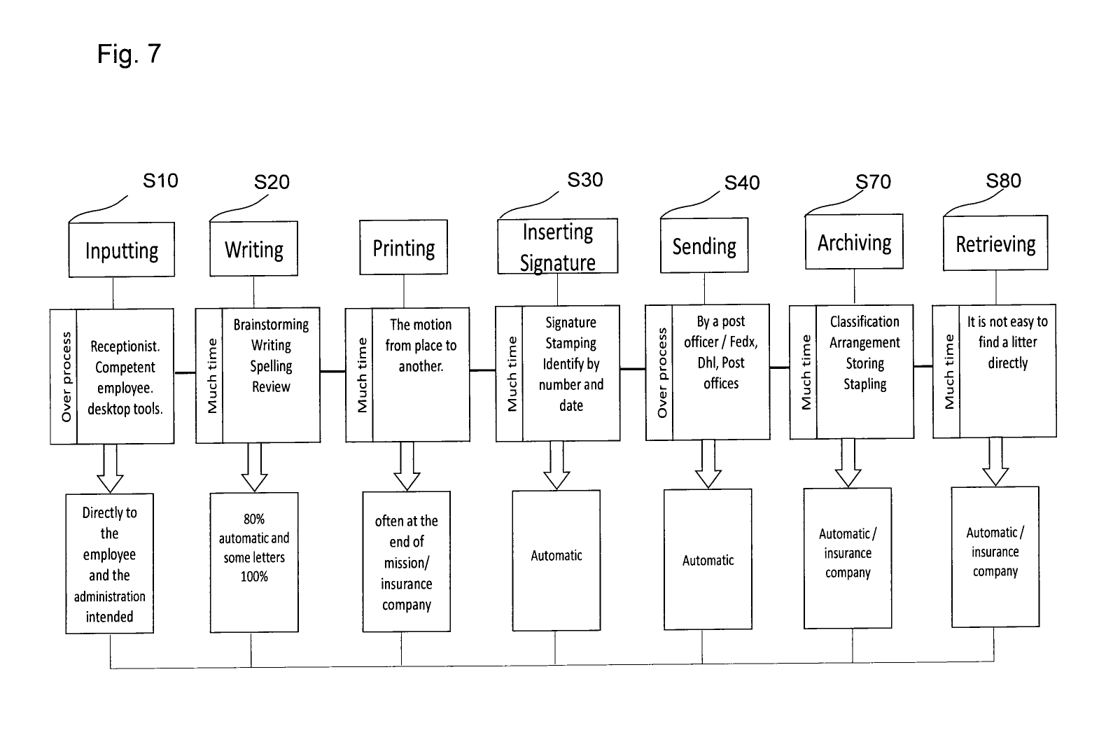

FIG. 7 is a block diagram representation of the main steps implemented by the communication apparatus 1000, according to one or more embodiments of the disclosed subject matter.

The system, apparatus, method and computer product disclosed in this application can be configured to automatically manage, generate and exchange official messages between the first party 3000 and the second party 5000. To automatically manage, generate and send official messages between the first party 3000 and the second party 5000, the step S10 of receiving the input request 3100, the step S20 of writing the output reply 5100, the step of printing the output reply 5100, the step S30 of generating anti-counterfeit operations, the step S40 of inserting the identifier 5110, the step of archiving S70, the step S80 of retrieving supplementary copies of the output reply 3100 are all performed automatically by the apparatus 1000, see FIG. 3 and corresponding descriptions for more details.

The automatic implementation of the steps S10, S20, S30, S40, S70 and/or S80 can reduce manual interventions and make the communication between the first party 3000 and the second party 5000 faster and more economical than conventional systems and/or method that completely rely on manual interventions to communicate.

The embodiments of the disclosed subject matter are directed to apparatus, method, and computer product to automatically manage, generate and send official messages, between two or more parties. The apparatus, method, and computer product can also be configured to determine the primary purpose and emergency of the official messages between the different involved parties, e.g., the first party 3000 and the second party 5000, by extracting key information and/or keywords contained in the official messages. The apparatus, method, and computer product can also be configured to generate the official messages in a fully automatic way, i.e., without any manual intervention, or in a partially automatic way, i.e., with manual intervention.

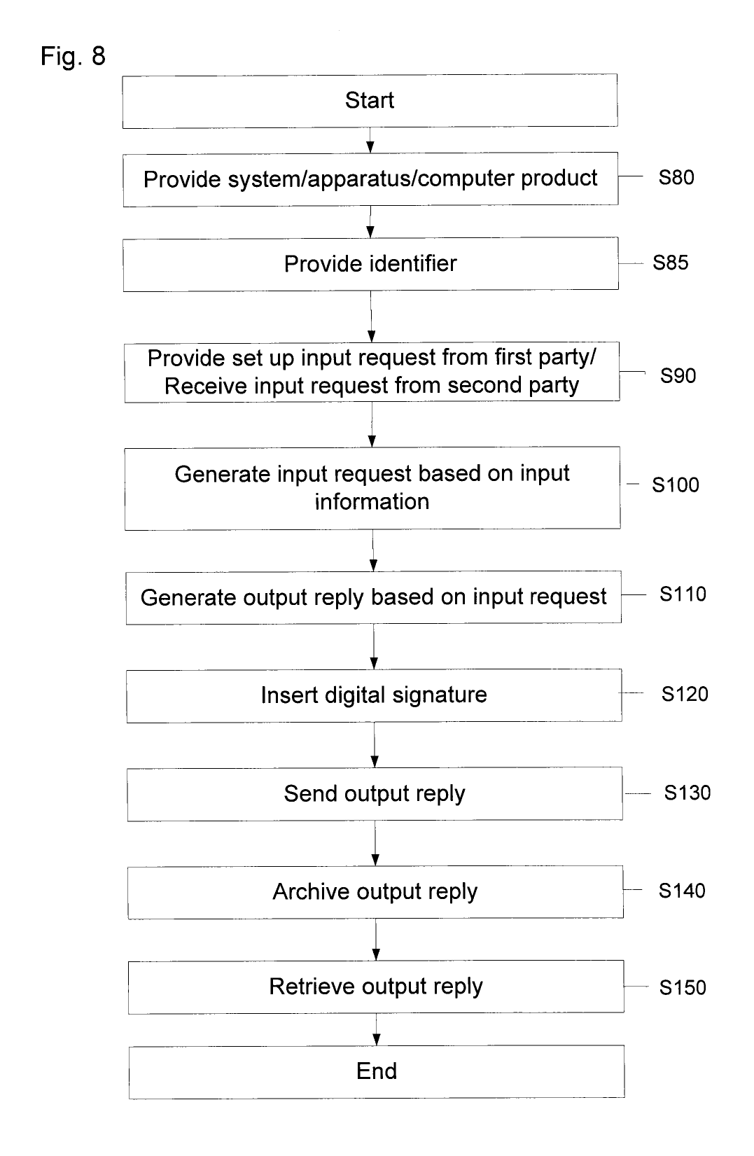

FIG. 8 is a basic flow chart of a method or operations according to one or more embodiments of the disclosed subject matter, implemented, for instance, using the communication apparatus 1000 of FIG. 1.

Optionally, in a step S80, a communication apparatus, such as communication apparatus 1000 (or system, apparatus or computer program product), can be provided.

In a step S85, an identifier may be provided. Generally speaking, the identifier may be a computer-readable pattern or arrangement, such as a bar code or a QR code.

At S90, a set up request to set up an input request may be provide by a first party. Additionally or alternatively, an input request may be received by a second party.

At S100, an input request may be generated, for instance, based on input information. Optionally, the input request can be or include one of a requester code and a receiver code, such as described herein.

In a step S110, an output reply can be generated based on the input request. Optionally, the output reply can be generated based on FIG. 4 and corresponding description above.

In a step S120, anti-counterfeit operations can be performed to the output reply prior to being output. For example, a unique bar code, watermark, embedded circuitry, and/or a digital signature can be added to the output reply, depending upon the physical or electronic format of the output reply, for instance, to show that authentication and integrity of the reply message, e.g., the output reply was not altered or modified. For example, insertion of the digital signature can be performed relying key generation instructions, signing instructions, and signature verifying instructions. The key generation instructions can randomly provide a private key and a corresponding public key, the signing instructions can produce a signature from the private key an a message, and the signature verifying instructions can from the public key and the signature either accept or reject the message.

In a step S130, the output reply can be output, for instance, as an official document or official data or information. For instance, hard and/or soft copies of the output reply can be provided.

In a step S140, which may be performed prior to or simultaneous with S130, the output reply can be archived, for instance, by the communication apparatus 1000. For example, a first soft copy of the output reply can be stored in memory of the communication apparatus 1000. Optionally or alternatively, another hard copy of the output reply can be generated and, for instance, placed into one bin of the plurality of bins of the communication apparatus 1000.

In a step S150, the first party and/or the second party can retrieve a supplementary copy of the output reply, wherein the supplementary copy of the output reply may be the hard copy archived in S140. The supplementary copy may be retrieved only by the first party, only by the second party, and/or only by a third party (e.g., a trusted courier), for instance, using a unique physical or electronic key to open the bin 1006.

Thus, certain aspects of the disclosed subject matter can comprise or provide:

(1) A communication apparatus, the communication apparatus comprising: an input slot to receive an input request; a scanner to generate a soft copy of the input request; a controller configured to process the soft copy of the input reply and provide an output reply; a printer to print a first hard copy of the output reply and a second hard copy of the output reply; an output slot to dispense the first hard copy of the output reply; and a plurality of bins to store the second hard copy of the output reply.

(2) The communication apparatus of (1), wherein the output reply includes an identifier and a digital signature.

(3) The communication apparatus of (1) or (2), wherein the identifier is an optical machine-readable representation of data.

(4) The communication apparatus of any one of (1) to (3), wherein the controller is further configured to extract key inputs from the soft copy of the input request, and select a template from a plurality of templates based on the key inputs.

(5) The communication apparatus of any one of (1) to (4), wherein the key inputs include at least one of a name, a date, an address, a document number, and an identification number.

(6) The communication apparatus of any one of (1) to (5), wherein the input slot and the scanner are configured to provide a reading of physical identification documents.

(7) The communication apparatus of any one of (1) to (6), wherein the controller is further configured to extract key identification elements from the reading of the physical identification documents.

(8) The communication apparatus of any one of (1) to (7), wherein the physical identification documents includes at least one of a document issued by a government of a country and a payment card.

(9) A communication apparatus, comprising: an input slot to receive an input request; an display and input device to input key inputs for the input request; a scanner to generate a soft copy of the input request; a controller configured to process the soft copy of the input request and provide an output reply; a printer to print a first hard copy of the output reply and a second hard copy of the output reply; an output slot to dispense the first hard copy of the output reply; and a plurality of bins to store the second hard copy of the output reply.

(10) The communication apparatus of (9), wherein the output reply includes an identifier and a digital signature.

(11) The communication apparatus of (9) or (10), wherein the identifier is an optical machine-readable representation of data.

(12) The communication apparatus of any one of (9) to (11), wherein the controller is further configured to select a template from a plurality of templates based on the key inputs.

(13) The communication apparatus of any one of (9) to (12), wherein the key inputs include at least one of a name, a date, an address, a document number, an identification number.

(14) The communication apparatus of any one of (9) to (13), wherein the input slot and the scanner are configured to provide a reading of physical identification documents.

(15) The communication apparatus of any one of (9) to (14), wherein the controller is further configured to extract key identification elements from the reading of the physical identification documents.

(16) The communication apparatus of any one of (9) to (15), wherein the physical identification documents includes at least one of a document issued by a government of a country and a payment card.

(17) A method to generate an official communication with a communication apparatus, the method comprising: receiving a input request from a first party via an input slot of the communication apparatus; generating a soft copy of the input request via a scanner of the communication apparatus; generating an output reply from the soft copy of the input request via software instructions performed by a controller of the communication apparatus; inserting a digital signature on the output reply via software instructions performed by the controller; inserting an identifier on the output reply via software instructions performed by the controller; generating a first hard copy of the output reply and a second hard copy of the output reply with a printer of the communication apparatus; archiving the first hard copy in at least one bin of a plurality of bins of the communication apparatus; and dispensing the second hard copy through an output slot of the communication apparatus.

(18) The method of (17), wherein the generating the output reply from the soft copy of the input request further includes: extracting key inputs from the soft copy of the request input; selecting a template from a plurality of templates based on the key inputs, each template of the plurality of templates including a plurality of fields to be filled by the key inputs; filling the plurality of fields with the key inputs to form the output reply; computing a completeness level of the output reply; and completing manually the output reply.

(19) The method of (17) or (18), wherein the selecting the template further includes assigning to each template of the plurality of templates a matching parameter.

(20) The method of any one of (17) to (19), wherein the matching parameter indicates for each template how many field of the plurality of fields can be completed from the key inputs.

(21) A non-transitory computer-readable storage medium storing computer-readable instructions that, when executed by a computer, cause the computer to perform a method according to any one of (17) to (20).

(22) An apparatus to generate and output an official communication document comprising: memory; and circuitry configured to receive an input request from a user requesting the official communication document, the input request including data comprised of one or more of a name, a date, an address, a document number, and an electronically readable pattern, transform the input request into a predetermined electronic format, select, responsive to the received input request, a predetermined official communication document template from among a plurality of predetermined official communication document templates stored in the memory, the predetermined official communication document template having a plurality of predefined portions for population with data, set the selected predetermined official communication document template as an intermediate official communication document having the predefined portions for population with data, determine which data of the input request with which to populate the predefined portions of the intermediate official communication document, populate a first portion of the predefined portions of the intermediate official communication document with the determined data of the input request, based on the received input request, receive data from a database, and populate a second portion of the predefined portions of the intermediate official communication document with data received from the database, determine whether the intermediate official communication document is sufficiently populated with the determined data of the input request and the data received from the database, when the intermediate official communication document is not sufficiently populated, output a request to the user to provide additional data to sufficiently populate the predefined portions of the intermediate official communication document, and receive the requested additional data until the predefined portions of the intermediate official communication document are sufficiently populated, when the predefined portions of the intermediate official communication document are sufficiently populated, electronically add a digital signature and document identification data to the intermediate official communication document to create a finalized official communication document, and output the finalized official communication document to the user as the official communication document.

(23) The apparatus of (22), wherein the input request includes the electronically readable pattern, the electronically readable pattern being one or more of a bar code and a quick read (QR) code.

(24) The apparatus of (22) or (23), further comprising: an input port to receive the input request from the user, the input request being in the form of a physical object; a scanner configured to transform the input request into the predetermined electronic format; a printer to print the finalized official communication document; an output port to dispense the finalized official communication document to the user as the official communication document.

(25) The apparatus of any one of (22) to (24), wherein the transforming the input request into the predetermined electronic format includes extracting from the input request key data in the form of the one or more of the name, the date, the address, the document number, and the electronically readable pattern.

(26) The apparatus of any one of (22) to (25), wherein the input request is an electronic message sent by a portable electronic device of the user.

(27) The apparatus of any one of (22) to (26), wherein the input request is a physical object either issued by a government entity or a financial institution or an incorporated entity.

(28) The apparatus of any one of (22) to (27), wherein the intermediate official communication document is sufficiently populated with the determined data of the input request and the data received from the database when all of the predefined portions of the intermediate official communication document are populated.

(29) The apparatus of any one of (22) to (28), wherein the finalized official communication document output to the user as the official communication document is output in electronic format to a portable electronic device of the user.

(30) The apparatus of any one of (22) to (29), wherein the finalized official communication document output to the user as the official communication document is output in as a hardcopy in paper, paper-based, plastic, or plastic-based format.

(31) The apparatus of any one of (22) to (30), wherein the finalized official communication document output to the user as the official communication document is output on a physical object provided as the input request.

(32) The apparatus of any one of (22) to (31), wherein the additional data received in response to the request to the user to provide additional data to sufficiently populate the predefined portions of the intermediate official communication document constitutes part of the input request.

(33) A method to generate and output an official communication document comprising: receiving an input request from a user requesting the official communication document, the input request including data comprised of one or more of a name, a date, an address, a document number, and an electronically readable pattern; transforming, using circuitry, the input request into a predetermined electronic format; selecting, using the circuitry, responsive to said receiving the input request, a predetermined official communication document template from among a plurality of predetermined official communication document templates stored in memory, the predetermined official communication document template having a plurality of predefined portions for population with data; setting, using the circuitry, the selected predetermined official communication document template as an intermediate official communication document having the predefined portions for population with data; determining, using the circuitry, which data of the input request with which to populate the predefined portions of the intermediate official communication document; populating, using the circuitry, a first portion of the predefined portions of the intermediate official communication document with the determined data of the input request; based on the received input request, using the circuitry, receiving data from a database, and populating a second portion of the predefined portions of the intermediate official communication document with data received from the database; determining, using the circuitry, whether the intermediate official communication document is sufficiently populated with the determined data of the input request and the data received from the database; when the intermediate official communication document is not sufficiently populated, outputting, using the circuitry, a request to the user to provide additional data to sufficiently populate the predefined portions of the intermediate official communication document, and receiving, using the circuitry, the requested additional data until the predefined portions of the intermediate official communication document are sufficiently populated; when the predefined portions of the intermediate official communication document are sufficiently populated, electronically adding, using the circuitry, a digital signature and document identification data to the intermediate official communication document to create a finalized official communication document; and outputting the finalized official communication document to the user as the official communication document.

(34) The method of (33), wherein the input request includes the electronically readable pattern, the electronically readable pattern being one or more of a bar code and a quick read (QR) code.

(35) The method of (33) or (34), wherein said transforming the input request into the predetermined electronic format includes extracting from the input request key data in the form of the one or more of the name, the date, the address, the document number, and the electronically readable pattern.

(36) The method of any one of (33) to (35), wherein the input request is an electronic message sent by a portable electronic device of the user.

(37) The method of any one of (33) to (36), wherein the input request is a physical object either issued by a government entity or a financial institution or an incorporated entity.

(38) The method of any one of (33) to (37), wherein the intermediate official communication document is sufficiently populated with the determined data of the input request and the data received from the database when all of the predefined portions of the intermediate official communication document are populated.

(39) The method of any one of (33) to (38), wherein the finalized official communication document output to the user as the official communication document is output as one or more of in electronic format to a portable electronic device of the user, as a hardcopy in paper, paper-based, plastic, or plastic-based format, and on a physical object provided as the input request.

(40) The method of any one of (33) to (39), wherein, when the predefined portions of the intermediate official communication document are not sufficiently populated, the intermediate official communication document is indirectly sent to an intermediate receiver, and the intermediate receiver manually populates the portions of the intermediate official communication document, and when the predefined portions of the intermediate official communication document are sufficiently populated, the official communication document is directly sent to a receiver account of the user via an electronic transmission.

(41) A non-transitory computer-readable storage medium storing computer-readable instructions that, when executed by a computer, cause the computer to perform a method to generate and output an official communication document, the method comprising: transforming a received input request requesting the official communication document into a predetermined electronic format, the input request including data comprised of one or more of a name, a date, an address, a document number, and an electronically readable pattern; selecting, based on the input request, a predetermined official communication document template from among a plurality of predetermined official communication document templates stored in memory, the predetermined official communication document template having a plurality of predefined portions for population with data; setting the selected predetermined official communication document template as an intermediate official communication document having the predefined portions for population with data; determining which data of the input request with which to populate the predefined portions of the intermediate official communication document; populating a first portion of the predefined portions of the intermediate official communication document with the determined data of the input request; based on the received input request, receiving data from a database, and populating a second portion of the predefined portions of the intermediate official communication document with data received from the database; determining whether the intermediate official communication document is sufficiently populated with the determined data of the input request and the data received from the database; when the intermediate official communication document is not sufficiently populated, outputting a request to the user to provide additional data to sufficiently populate the predefined portions of the intermediate official communication document, and receiving the requested additional data until the predefined portions of the intermediate official communication document are sufficiently populated; when the predefined portions of the intermediate official communication document are sufficiently populated, electronically adding a digital signature and document identification data to the intermediate official communication document to create a finalized official communication document as the official communication document.

(42) The non-transitory computer-readable storage medium of (41), further comprising electronically storing in one or more of the memory and the database the finalized official communication document as the official communication document.

(43) A non-transitory computer-readable storage medium storing computer-readable instructions that, when executed by a computer, cause the computer to perform a method comprising: receiving an input request from a user requesting the official communication document, the input request including data comprised of one or more of a name, a date, an address, a document number, and an electronically readable pattern; transforming the input request into a predetermined electronic format; selecting responsive to said receiving the input request, a predetermined official communication document template from among a plurality of predetermined official communication document templates stored in memory, the predetermined official communication document template having a plurality of predefined portions for population with data; setting the selected predetermined official communication document template as an intermediate official communication document having the predefined portions for population with data; determining which data of the input request with which to populate the predefined portions of the intermediate official communication document; populating a first portion of the predefined portions of the intermediate official communication document with the determined data of the input request; based on the received input request receiving data from a database, and populating a second portion of the predefined portions of the intermediate official communication document with data received from the database; determining whether the intermediate official communication document is sufficiently populated with the determined data of the input request and the data received from the database; when the predefined portions of the intermediate official communication document are not sufficiently populated the intermediate official communication document is indirectly sent to an intermediate receiver, the intermediate receiver manually populates the portions of the intermediate official communication document; and when the predefined portions of the intermediate official communication document are sufficiently populated the official communication document is directly sent on a requester account of the user via an electronic transmission; and outputting the finalized official communication document to the user as the official communication document.

(44) A non-transitory computer-readable storage medium storing computer-readable instructions that, when executed by a computer, cause the computer to perform a method comprising: receiving an input request from a user requesting an official document; determining whether the input request includes a requester code comprised of a requester account, subject and request or a receiver code comprised of a receiver account and requester subject and request or code; when said determining determines that the requester code is included in the input request, indirectly sending a finalized official document to the user by first sending an intermediate official document to a computer or apparatus operated by a human, who is different from the user, to add missing data to the intermediate official document prior to finalizing the official document and sending the finalized official document to the user; and when said determining determines that the receiver code is included in the input request, directly sending the finalized official document to the user without intervention by the human so long as the finalized official document includes full text for the finalized official document, otherwise, indirectly sending the finalized official document to the user by first sending the intermediate official document to the computer or apparatus operated by the human to add missing data to the intermediate official document prior to finalizing the official document, wherein, prior to sending to the user, the finalized official document is modified to include a digital signature.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure, are within the scope of one of ordinary skill in the art, and are contemplated as falling within the scope of the disclosed subject matter and any equivalents thereto. Features of the disclosed embodiments can be combined, rearranged, omitted, etc., within the scope of the disclosed subject matter to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

What is claimed is:

1. An apparatus to generate and output an official communication document comprising:
memory; and
circuitry configured to
receive an input request from a user requesting the official communication document, the input request including data comprised of one or more of a name, a date, an address, a document number, and an electronically readable pattern,
transform the input request into a predetermined electronic format,
select, responsive to the received input request, a predetermined official communication document template from among a plurality of predetermined official communication document templates stored in the memory, the predetermined official communication document template having a plurality of predefined portions for population with data,
set the selected predetermined official communication document template as an intermediate official communication document having the predefined portions for population with data,
determine which data of the input request with which to populate the predefined portions of the intermediate official communication document,
populate a first portion of the predefined portions of the intermediate official communication document with the determined data of the input request,
based on the received input request, receive data from a database, and populate a second portion of the predefined portions of the intermediate official communication document with data received from the database,
determine whether the intermediate official communication document is sufficiently populated with the determined data of the input request and the data received from the database,
when the intermediate official communication document is not sufficiently populated, output a request to the user to provide additional data to sufficiently populate the predefined portions of the intermediate official communication document, and receive the requested additional data until the predefined portions of the intermediate official communication document are sufficiently populated,
when the predefined portions of the intermediate official communication document are sufficiently populated, electronically add a digital signature and document identification data to the intermediate official communication document to create a finalized official communication document, and
output the finalized official communication document to the user as the official communication document.

2. The apparatus of claim 1, wherein the input request includes the electronically readable pattern, the electronically readable pattern being one or more of a bar code and a quick read (QR) code.

3. The apparatus of claim 1, further comprising:
an input port to receive the input request from the user, the input request being in the form of a physical object;
a scanner configured to transform the input request into the predetermined electronic format;
a printer to print the finalized official communication document;
an output port to dispense the finalized official communication document to the user as the official communication document.

4. The apparatus of claim 1, wherein the transforming the input request into the predetermined electronic format includes extracting from the input request key data in the form of the one or more of the name, the date, the address, the document number, and the electronically readable pattern.

5. The apparatus of claim 1, wherein the input request is an electronic message sent by a portable electronic device of the user.

6. The apparatus of claim 1, wherein the input request is a physical object either issued by a government entity or a financial institution or an incorporated entity.

7. The apparatus of claim 1, wherein the intermediate official communication document is sufficiently populated with the determined data of the input request and the data received from the database when all of the predefined portions of the intermediate official communication document are populated.

8. The apparatus of claim 1, wherein the finalized official communication document output to the user as the official communication document is output in electronic format to a portable electronic device of the user.

9. The apparatus of claim 1, wherein the finalized official communication document output to the user as the official communication document is output in as a hardcopy in paper, paper-based, plastic, or plastic-based format.

10. The apparatus of claim 1, wherein the finalized official communication document output to the user as the official communication document is output on a physical object provided as the input request.

11. The apparatus of claim 1, wherein the additional data received in response to the request to the user to provide additional data to sufficiently populate the predefined portions of the intermediate official communication document constitutes part of the input request.

12. A method to generate and output an official communication document comprising:
receiving an input request from a user requesting the official communication document, the input request including data comprised of one or more of a name, a date, an address, a document number, and an electronically readable pattern;
transforming, using circuitry, the input request into a predetermined electronic format;
selecting, using the circuitry, responsive to said receiving the input request, a predetermined official communication document template from among a plurality of predetermined official communication document templates stored in memory, the predetermined official communication document template having a plurality of predefined portions for population with data;
setting, using the circuitry, the selected predetermined official communication document template as an intermediate official communication document having the predefined portions for population with data;
determining, using the circuitry, which data of the input request with which to populate the predefined portions of the intermediate official communication document;
populating, using the circuitry, a first portion of the predefined portions of the intermediate official communication document with the determined data of the input request;
based on the received input request, using the circuitry, receiving data from a database, and populating a second portion of the predefined portions of the intermediate official communication document with data received from the database;
determining, using the circuitry, whether the intermediate official communication document is sufficiently populated with the determined data of the input request and the data received from the database;
when the intermediate official communication document is not sufficiently populated, outputting, using the circuitry, a request to the user to provide additional data to sufficiently populate the predefined portions of the intermediate official communication document, and receiving, using the circuitry, the requested additional data until the predefined portions of the intermediate official communication document are sufficiently populated;
when the predefined portions of the intermediate official communication document are sufficiently populated, electronically adding, using the circuitry, a digital signature and document identification data to the intermediate official communication document to create a finalized official communication document; and
outputting the finalized official communication document to the user as the official communication document.

13. The method of claim 12, wherein the input request includes the electronically readable pattern, the electronically readable pattern being one or more of a bar code and a quick read (QR) code.

14. The method of claim 12, wherein said transforming the input request into the predetermined electronic format includes extracting from the input request key data in the form of the one or more of the name, the date, the address, the document number, and the electronically readable pattern.

15. The method of claim 12, wherein the input request is an electronic message sent by a portable electronic device of the user.

16. The method of claim 12, wherein the input request is a physical object either issued by a government entity or a financial institution or an incorporated entity.

17. The method of claim 12, wherein the intermediate official communication document is sufficiently populated with the determined data of the input request and the data received from the database when all of the predefined portions of the intermediate official communication document are populated.

18. The method of claim 12, wherein the finalized official communication document output to the user as the official communication document is output as one or more of in electronic format to a portable electronic device of the user, as a hardcopy in paper, paper-based, plastic, or plastic-based format, and on a physical object provided as the input request.

19. The method of claim 12,
wherein, when the predefined portions of the intermediate official communication document are not sufficiently populated, the intermediate official communication document is indirectly sent to an intermediate receiver, and the intermediate receiver manually populates the portions of the intermediate official communication document, and
wherein, when the predefined portions of the intermediate official communication document are sufficiently populated, the official communication document is directly sent to a receiver account of the user via an electronic transmission.

20. A non-transitory computer-readable storage medium storing computer-readable instructions that, when executed by a computer, cause the computer to perform a method comprising:
receiving an input request from a user requesting an official document;
determining whether the input request includes a requester code comprised of a requester account, subject and request or a receiver code comprised of a receiver account and requester subject and request or code;
when said determining determines that the requester code is included in the input request, indirectly sending a finalized official document to the user by first sending an intermediate official document to a computer or apparatus operated by a human, who is different from the user, to add missing data to the intermediate official document prior to finalizing the official document and sending the finalized official document to the user; and
when said determining determines that the receiver code is included in the input request, directly sending the finalized official document to the user without intervention by the human so long as the finalized official document includes full text for the finalized official document, otherwise, indirectly sending the finalized official document to the user by first sending the intermediate official document to the computer or apparatus operated by the human to add missing data to the intermediate official document prior to finalizing the official document,
wherein, prior to sending to the user, the finalized official document is modified to include a digital signature.
